(19) United States
(12) Patent Application Publication
(10) Pub. No.: US 2022/0303230 A1
(43) Pub. Date: Sep. 22, 2022

(54) OPERATIONS TO COPY PORTIONS OF A PACKET

(71) Applicant: Intel Corporation, Santa Clara, CA (US)

(72) Inventors: Ping YU, Shanghai (CN); Sarig LIVNE, Schanya (IL); Qi ZHANG, Shanghai (CN); Xuan DING, Shanghai (CN); Raul DIAZ, Palo Alto, CA (US); Pawel SZYMANSKI, Gdansk (PL)

(21) Appl. No.: 17/830,814

(22) Filed: Jun. 2, 2022

(30) Foreign Application Priority Data
Mar. 30, 2022 (CN) PCT/CN2022/083972

(51) Int. Cl. H04L 49/90; H04L 69/22; H04L 49/00; H04L 69/16; H04L 69/166

(52) U.S. Cl. CPC H04L 49/9042; H04L 69/22; H04L 49/3072; H04L 69/161; H04L 69/166

(57) ABSTRACT

Examples described herein relate to a network interface device to perform header splitting with payload reordering for one or more packets received at the network interface device and copy headers and/or payloads associated with the one or more packets to at least one memory device.

### RELATED APPLICATION

This application claims the benefit of priority to Patent Cooperation Treaty (PCT) Application No. PCT/CN2022/083972 filed Mar. 30, 2022. The entire content of that application is incorporated by reference.

### BACKGROUND

Networking protocols define a manner of transmitting packets from a transmitter to a receiver. Various protocols are stateful protocols whereby an order of transmission and receipt is specified by a transmitter and the receiver attempts to reconstruct a sequence of packet transmissions. For example, Transmission Control Protocol (TCP) defines a stateful protocol that attempts to provide reliable transport of packets and order of delivery of packets at the receiver. When a packet is received from a network interface controller (NIC), the full packet is copied to host memory. A driver can provide a descriptor to the NIC and identify a single dedicated buffer address, and the NIC can copy a received packet to the buffer.

### BRIEF DESCRIPTION OF THE DRAWINGS

FIG. 1 depicts an example manner to copy portions of a received packet to memory.

FIG. 2 depicts an example scenario of packet receipt that is out of order.

FIG. 3 depicts an example system.

FIG. 4 depicts an overview of operations.

FIG. 5A depicts an example of an Real-time Transport Protocol (RTP) header.

FIG. 5B depicts an example operation of packet ordering at a received for RTP.

FIG. 6A depicts an example operation of storing data from received RTP packets in order.

FIG. 6B depicts an example of allocation of buffers to reorder lines of frames.

FIG. 6C depicts an example of a manner of allocating buffers to frames.

FIG. 6D depicts an example of allocation of lines from received packets to frames.

FIG. 7 depicts an example process.

FIG. 8 depicts an example network interface device.

FIG. 9 depicts a system.

FIG. 10 depicts a system.

### DETAILED DESCRIPTION

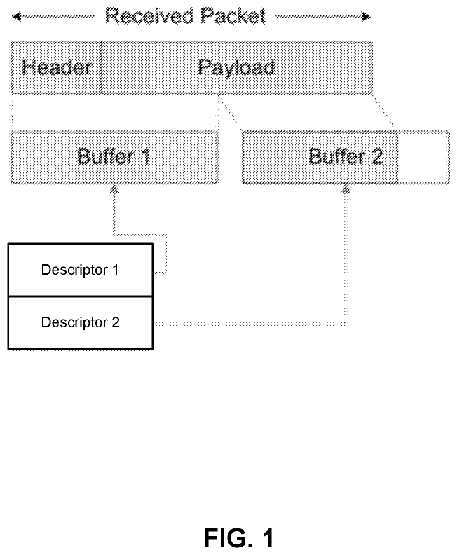

FIG. 1 depicts an example manner to copy portions of a received packet to memory. To reduce a number of memory copy operations arising from copying packet header and packet payload to a memory, a driver can provide descriptors to identify two memory buffers to be written-to by a NIC, and the NIC can copy portions of the packet into two different buffers. For example, the NIC can copy a packet header to a first buffer and copy the packet payload to a different buffer. Copying header and/or payload to buffers can be stateless and not consider order of transmission or order of payload reconstruction. When a packet is lost or received out of order, the NIC copies the packet to pre-defined buffer addresses based on order of arrival.

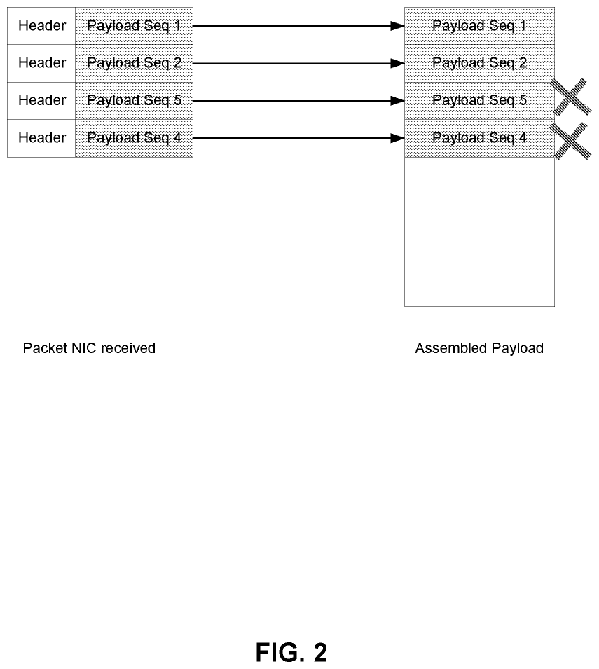

FIG. 2 depicts an example scenario of packet receipt that is out of order. In this example, payloads were transmitted with sequence numbers increasing from 1 to 5 but received in order of 1, 2, 5, and 4, with sequence number 3 missing. Packets with sequence numbers of 1, 2, 5, and 4 can be copied to memory buffers but are out of order by stateless copying of received packets to payload buffers.

In some cases, payload ordering in buffers is context sensitive and payloads are to be read out from buffers or delivered to an application or operating system in a particular transmitter-specified order. For example, when processing stateful protocols such as TCP or User Datagram Protocol (UDP) packets, and there are lost or packet received out of order, the posted payload can be placed out of order relative to other previously received payloads. As a result, a payload buffer may not store data arranged in a correct transmitter-specified order. For example, in the media broadcast industry, raw video is transmitted using stateful protocols such as Real-time Transport Protocol (RTP). An example RTP protocol is defined by RFC 4175 (2005), as well as variations and derivatives thereof. RTP defines reconstruction of transmitted packets at a receiver based on timestamps (e.g., Raw ID and Raw offset). Out of order delivery of packets may not provide packet payloads in increasing timestamp order.

At least to provide ordered storage of received packet contents into one or more buffers, such as when layer 4 (L4) stateful protocols are used, packet order information specified in headers and/or payloads of received packets can be read by a receiver network interface device and the receiver network interface device can store portions of received packets in one or more buffers in an order based on the packet order information and offset from a base address. Packet order information can include, at least, offset or sequence number. To identify available buffers and corresponding memory addresses to store portions of the received packets, the receiver network interface device can access receive descriptors that identify available buffers. In some examples, to copy portions of the received packets to one or more buffers, the receiver network interface device can include programmable circuitry that classifies and distributes packets to specified queues or buffers in host memory.

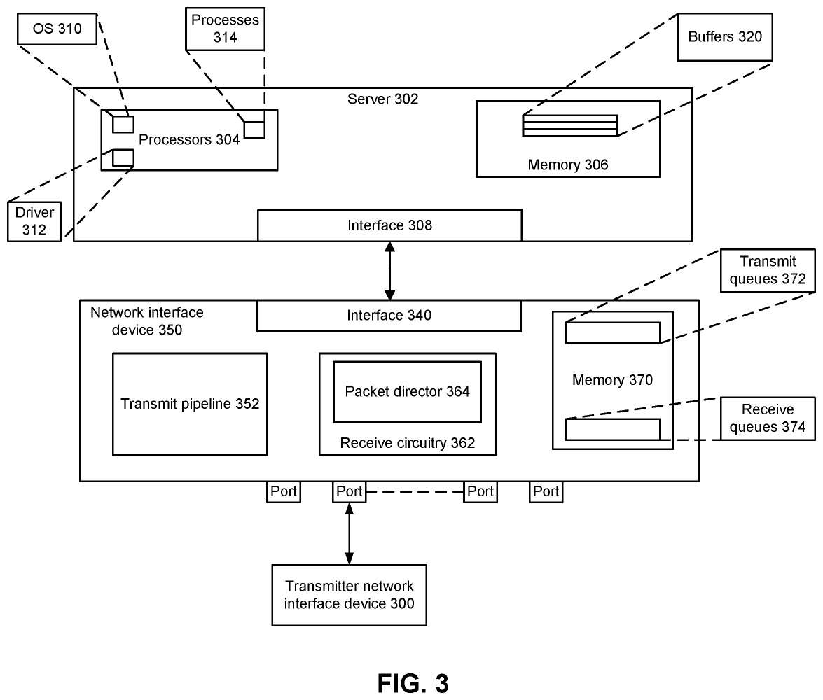

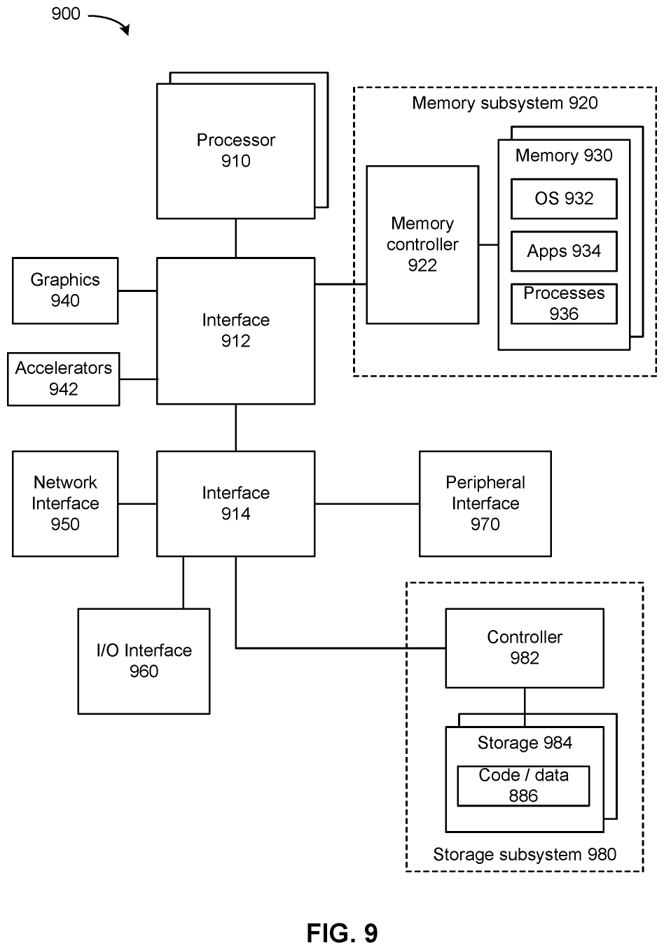

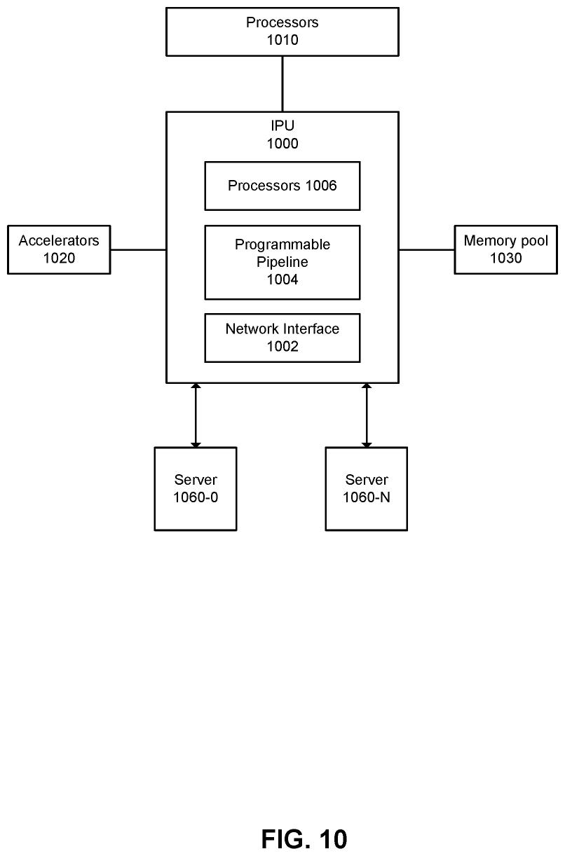

FIG. 3 depicts an example system. Server 302 can include or access one or more processors 304, memory 306, and device interface 308, among other components described herein (e.g., accelerator devices, interconnects, and other circuitry). Processors 304 can execute one or more processes 314 (e.g., microservices, virtual machines (VMs), containers, or other distributed or virtualized execution environments) that utilize or request transmission of packets at particular timeslots by specifying transmit timestamps. Various examples of processors 304 are described herein at least with respect to FIG. 9 and/or FIG. 10.

Packet transmission between network interface device 300 and network interface device 350 can utilize transport technologies such as Transmission Control Protocol (TCP), User Datagram Protocol (UDP), quick UDP Internet Connections (QUIC), remote direct memory access (RDMA) over Converged Ethernet (RoCE), Amazon's scalable reliable datagram (SRD), High Precision Congestion Control (HPCC) (e.g., Li et al., “HPCC: High Precision Congestion Control” SIGCOMM (2019)), or other reliable transport protocols.

In some examples, processes 314 can utilize Real-time Transport Protocol (RTP) with Real-time Control Protocol (RTCP) for media stream transmission or receipt between transmitter network interface device 300 to network interface device 350. RTP can be used to transmit the media stream (e.g., video, audio, and/or metadata), whereas RTCP can be used to monitor transmission statistics and quality of service (QoS) and aids in the synchronization of audio and video streams. An example of RTP is described in RFC 3550 (2003) and variations and derivatives thereof. RTP carries the media streams (e.g., audio and video). Other control protocols (signaling protocols) can be used such as International Telecommunication Union Telecommunication Standardization Sector (ITU-T) H.323, Session Initiation Protocol (SIP) or Jingle (XMPP). Packet formats can map MPEG-4 audio/video into RTP packets as specified in RFC 3016. Audio payload formats can include, but are not limited to, G.711, G.723, G.726, G.729, GSM, QCELP, MP3, and DTMF. Video payload formats can include, but are not limited to, H.261, H.263, H.264, H.265, and MPEG-1/MPEG-2. Packet formats to map MPEG-4 audio/video into RTP packets are specified, for example, in RFC 3016 (2000). For example, some media streaming services use the Dynamic Streaming over HTTP (DASH) protocol or HTTP Live Streaming (HLS). Some streaming protocols allow for control of media playback, recording, or pausing to provide real-time control of media streaming from the server to a client such as video-on-demand (VOD) or media on demand

Network interface device 300 and/or network interface device 350 can be implemented as one or more of: a network interface controller (NIC), a remote direct memory access (RDMA)-enabled NIC, SmartNIC, router, switch, forwarding element, infrastructure processing unit (IPU), or data processing unit (DPU). Network interface device 350 can be communicatively coupled to interface 308 of server 302 using interface 340. Interface 308 and interface 340 can communicate based on Peripheral Component Interconnect Express (PCIe), Compute Express Link (CXL), or other connection technologies. See, for example, Peripheral Component Interconnect Express (PCIe) Base Specification 1.0 (2002), as well as earlier versions, later versions, and variations thereof. See, for example, Compute Express Link (CXL) Specification revision 2.0, version 0.7 (2019), as well as earlier versions, later versions, and variations thereof.

OS 310 can perform a networking stack that extracts the network layer, transport layer and in some cases application layer attributes and parses the network header, transport header and any other upper layer headers before passing the payload to the application. Operating system (OS) 310, driver 312, and/or processes 314 can configure packet director 364 of network interface device 350 with one or more fields of a packet header of a received packet or a flow that identify packets so that network interface device 350 is to copy one or more portions of such packets to positions or addresses in buffers 320 in memory 306 to reconstruct data in an order specified by a transmitter server and/or transmitter network interface device 300, as described herein.

In some examples, when an RTP raw video stream flow is established, OS 310, driver 312, and/or processes 314 can configure packet director 364 with base frame buffer base address and video format information. The buffer can allocated to store payloads of the RTP raw video stream flow.

Network interface device 350 can be configurable using an application program interface (API) by OS 310, driver 312, and/or processes 314 to enable or disable copy one or more portions of the packets to positions or addresses in buffers 320 in memory 306 to reconstruct data in an order specified by a transmitter server and/or transmitter network interface device 300. Driver 312 can be available from or consistent with Data Plane Development Kit (DPDK), OpenDataPlane (ODP), Infrastructure Programmer Development Kit (IPDK), or Linux®.

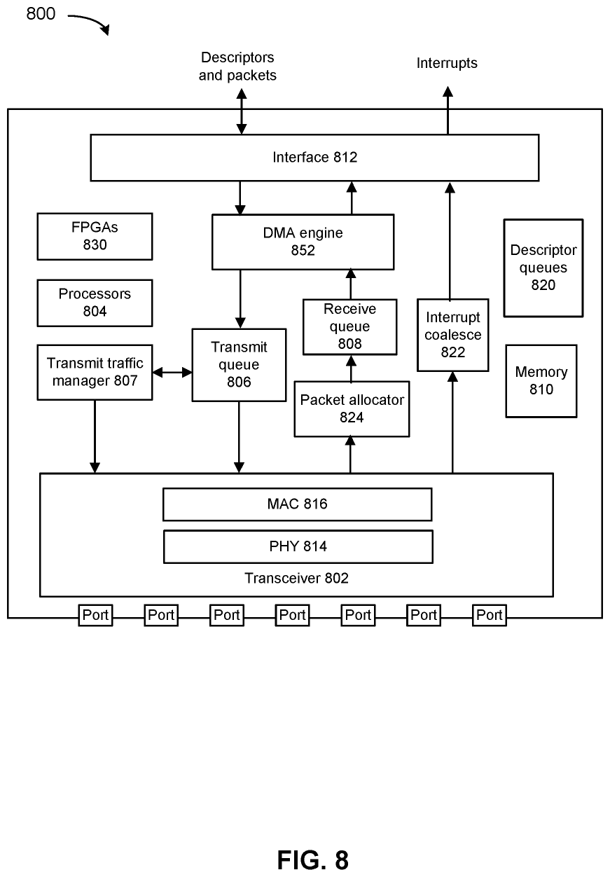

For example, receive circuitry 362 can include various technologies described with respect to FIG. 8 and can process packets received from a network. In some examples, receive circuitry 362 can include or access packet director 364 to determine buffers among buffers 320 to which to separately copy header and payload portions of received packets into buffers to perform header and/or payload reordering, as described herein. In some examples, packet director 364 can include features of Intel® Dynamic Device Personalization (DDP). Transmit pipeline 352 can include various technologies described with respect to FIG. 8 and can provide for packet transmission through one or more ports of network interface device 350.

In some examples, for one or more packets received at network interface device 350, packet director 364 can perform header splitting from packets and perform header and/or payload reordering in order cause storage of one or more packet headers and/or one or more packet payloads into a particular order in buffers 320. For example, packet director 364 can cause one or more packet headers to be stored into a particular order in buffers 320. For example, packet director 364 can cause one or more packet payloads to be stored into a particular order in buffers 320. Accordingly, packet director 364 can support reliable transport that is reorder tolerant.

In some examples, processes 314, OS 310, or other software can access received headers from a queue and, based on the headers, determine if all lines of a frame have been received or contiguous lines of a partial frame have arrived. A scoreboard can be used to identify lines of a frame that are received. Processes 314 can process the lines of a frame for display, retransmission (e.g., content distribution network (CDN)), and so forth.

OS 310, or other software, can implement a TCP stack to monitor packets that belong to a video frame (e.g., as identified by a time stamp) and determine when packets that carry a portions of a video frame have arrived. A time out can be used, and after the time out expires, the frame or partial frame can be dropped or passed to the user application (e.g., process 314) with missing video data if user application (e.g., process 314) can process the video. User application can accept or reject the frame or partial frame.

A flow can be a sequence of packets being transferred between two endpoints, generally representing a single session using a known protocol. Accordingly, a flow can be identified by a set of defined tuples and, for routing purpose, a flow is identified by the two tuples that identify the endpoints, e.g., the source and destination addresses. For content-based services (e.g., load balancer, firewall, intrusion detection system, etc.), flows can be differentiated at a finer granularity by using N-tuples (e.g., source address, destination address, IP protocol, transport layer source port, and destination port). A packet in a flow is expected to have the same set of tuples in the packet header. A packet flow to be controlled can be identified by a combination of tuples (e.g., Ethernet type field, source and/or destination IP address, source and/or destination User Datagram Protocol (UDP) ports, source/destination TCP ports, or any other header field) and a unique source and destination queue pair (QP) number or identifier. A packet may be used herein to refer to various formatted collections of bits that may be sent across a network, such as Ethernet frames, IP packets, TCP segments, UDP datagrams, etc. Also, as used in this document, references to L2, L3, L4, and L7 layers (layer 2, layer 3, layer 4, and layer 7) are references respectively to the second data link layer, the third network layer, the fourth transport layer, and the seventh application layer of the OSI (Open System Interconnection) layer model.

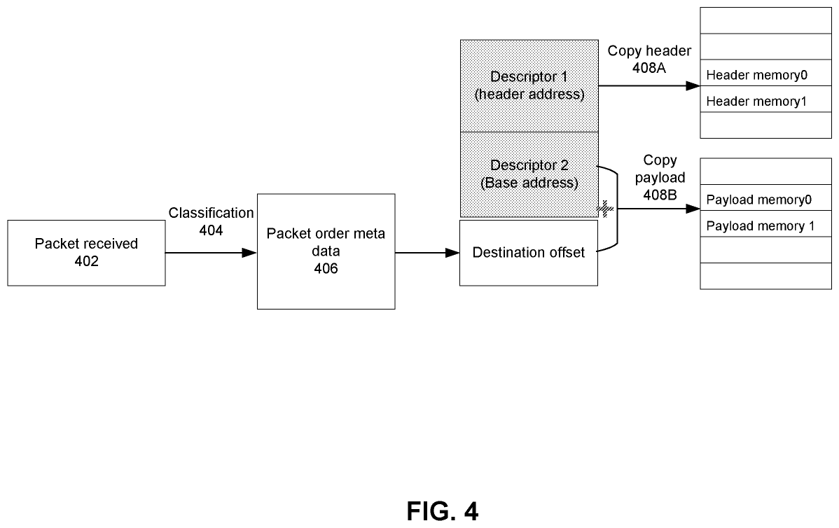

FIG. 4 depicts an overview of operations. At 402, a packet is received from a transmission medium (e.g., wired or wireless) at a network interface device. At 404, the network interface device can classify the received packet based on a profile that identifies a flow of the packet. The network interface device can place the packet payload in a calculated position in a buffer based on the packet time stamp. Based on the identified flow, the network interface device can provide packet order metadata from the received packet 406 for access by a process to determine whether one or more packets are missing. After a time window closes, the process can determine whether one or more packets are missing (e.g., packet gap). Packet order metadata 406 can include offset related fields based on the protocol, such as the TCP sequence number, RTP RFC 4175 line number, timestamp, length, line offset, or other information to derive a position in a buffer of the received packet.

A destination memory address or buffer can be determined based on a base address and an offset from packet order metadata 406. In some examples, one or more descriptors can be accessed by the network interface device to identify one or more buffers in which to store the received packet. In this example, the network interface device can identify two buffers to store the received packet based on two descriptors. A first descriptor can identify an available buffer or base address to store a header. A second descriptor can identify an available buffer or base address to store a payload. In some examples, the second descriptor can identify the base address.

The network interface device can utilize circuitry that calculates a destination for the header of the received packet and a destination for the payload of the received packet based on the base address, frame format information, and offset. An example of frame format information can refer to image or video frame information such as pixel group size, depth, and so forth. The frame format information can be used to determine a destination offset. By linking the base address and destination offset, the destination in payload memory can be calculated, and after a security check that the destination memory address is within an expected range of memory addresses, at 408A, the network interface device can write the header of the received packet into the calculated header buffer (Header memory0) by a direct memory access (DMA) operation and at 408B, the network interface device can write the payload of the received packet into the calculated payload buffer (Payload memory0) by a DMA operation. A subsequently received packet can be stored in header memory and payload memory (Header memory1 and Payload memory1) in an order specified by the transmitter.

The network interface device can extract from received packet header one or more of: Line ID (e.g., identifies line number where a packet includes a partial line or lower line number when a packet includes data that straddles two lines), Line Offset (e.g., number of bytes from a start of a line that the packet carries), or time stamp (e.g., one or more time stamp values associated with data carried by the packet).

Receive queue configured parameters can include one or more of: number of frames stored in buffer in host memory and allocated to reorder lines or frames, line size (e.g., number of columns in a frame or horizontal resolution), or video frame size (e.g., number of rows (lines)*number of columns*pixel size (KB)).

A reassembly context can be accessed to identify a frame and buffer for a time stamp value. In some examples, two reassembly contexts are used to reorder two different frames, but different numbers of contexts can be used. A reassembly context can be current frame context and have an associated Time Stamp and Frame Buffer ID or a next frame context and have an associated Time Stamp and Frame Buffer ID.

The following pseudocode depicts an example operation of a network interface device to perform reordering of lines in a frame and reordering among received frames. An integer N number of buffers are available to store packet data.

```
Based on received packet:
  Post header is to the header buffer (header split);
  If packet time stamp matches a timestamp for which a Frame Buffer ID
  is already assigned:
    use Frame Buffer ID to write content of received packet to buffer
    associated with Frame Buffer ID
  Else (new frame time stamp):
    Reuse oldest reassembly context for new frame time stamp:
      Store packet time stamp in time stamp field of reassembly
      context;
      Store ([Frame Buffer ID] + 1) and stored in Buffer ID field
  Copy payload of received packet written to buffer:
  Write Address = Base Address (from Descriptor) +
  FrameBufferID(Current/Next) x Frame Size + LineID x Line Size +
  LineOffset
```

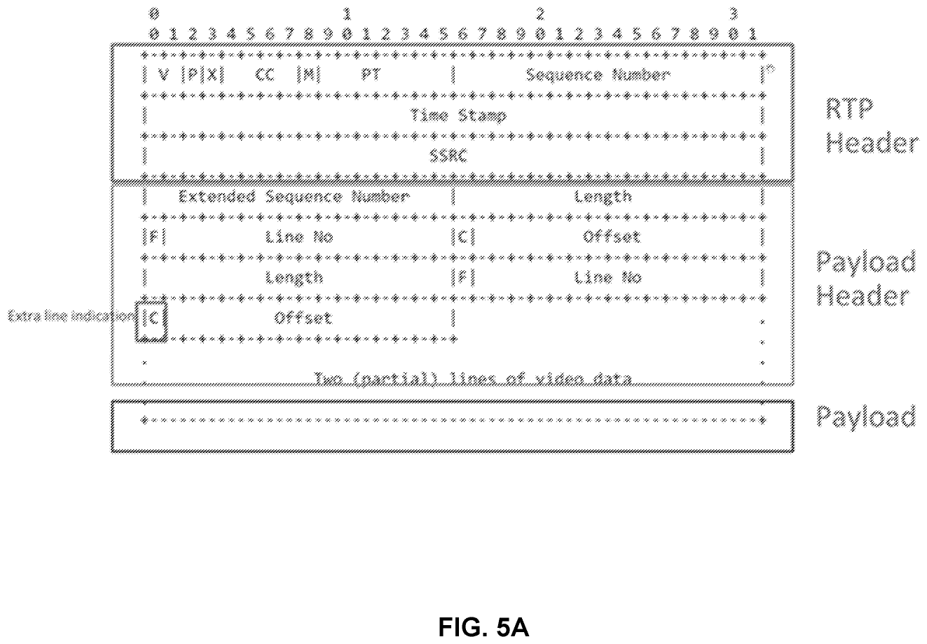

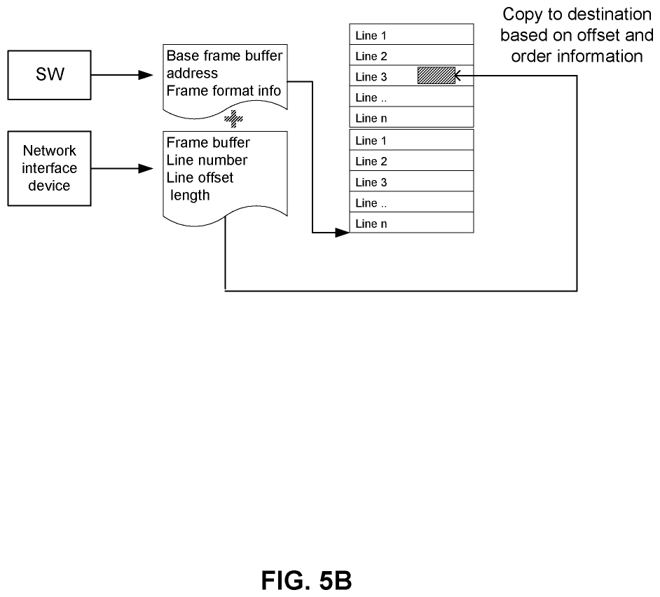

Internet Engineering Task Force (IETF) request for comments (RFC) 4175 (2005) describes a manner of transmitting uncompressed video over Real-time Transport Protocol (RTP). FIG. 5A depicts an example of an RTP header. An RTP header can indicate a position of data carried in an RTP packet relative to a position of data in other packets by specifying length, line number, time stamp, and offset. The length, line number, time stamp, and offset can be used so that the payload of the packet can be arranged in receiver memory in ascending or descending sequence numbers of time stamps.

RFC 4175 defines a format which indicates the payload line location and offset. When or after an RTP raw video stream flow is established, a driver or operating system (OS) can configure a network interface device with a policy including a base frame buffer base address and video format information so that the network interface device can copy received packets to receiver memory in specified order.

FIG. 5B depicts an example operation of packet ordering at a receiver for an RTP flow. Software (SW) such as a process, operating system (OS), driver, hypervisor, virtual machine manager (VMM), or other software, can configure the network interface device with a flow rule or policy including base frame buffer address and frame format information for the RTP flow. When a RTP packet in the RTP flow is received by the network interface device, the network interface device can extract fields such as timestamp, line number, and line offset. The network interface device can calculate a current frame index, line number and the offset of the line or lines received in the packet based on the base frame buffer address and frame format information. The network interface device can copy a header part and a payload part of the RTP packet to calculated destination buffers and maintain an order of payloads in buffers so that the lines of a frame of pixels are stored in order of lines and, potentially, time stamp order. A process can access the media data for processing or re-transmission.

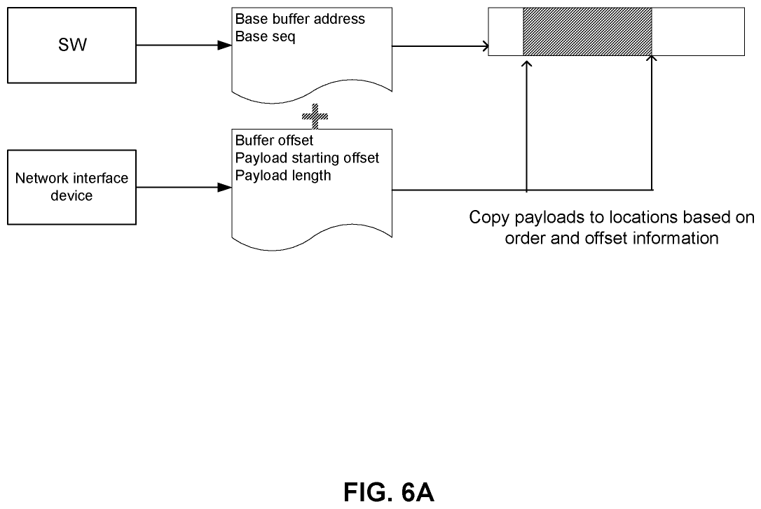

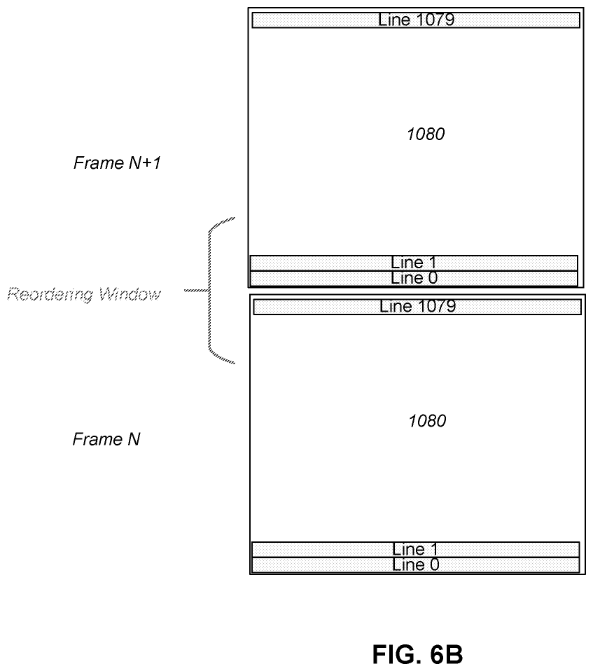

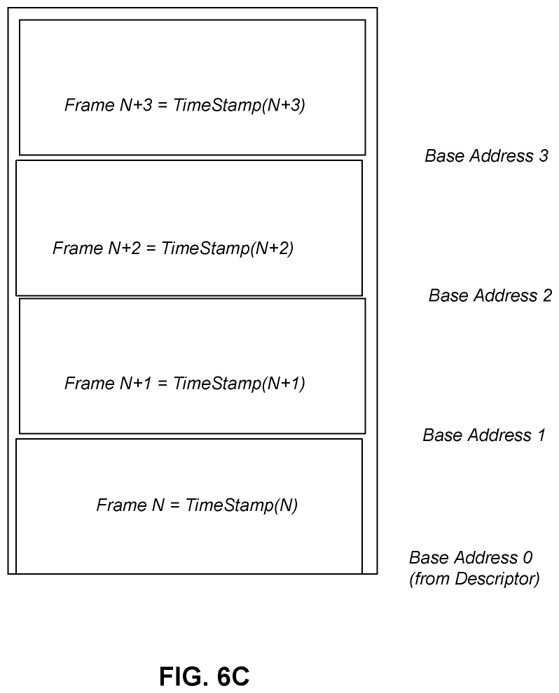

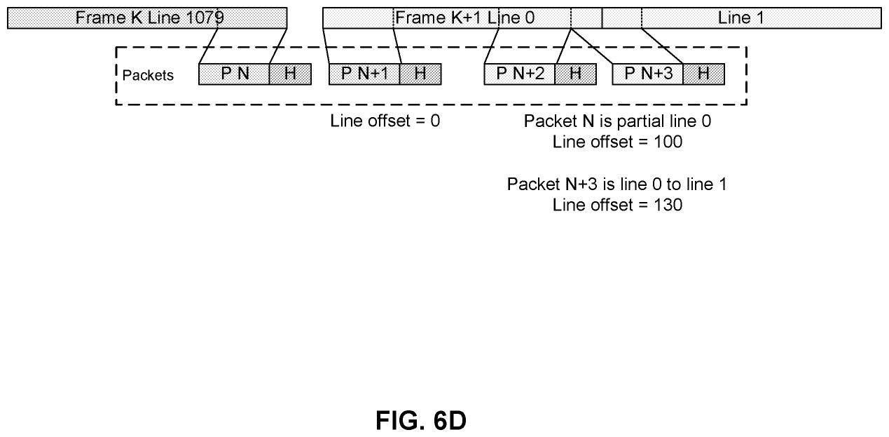

FIG. 6A depicts an example operation of storing data from RTP received packets in order. When a RTP connection is established, software (SW) such as a process, OS, driver, hypervisor, VMM, or other software, can allocate a buffer in host memory and create a descriptor that identifies the base buffer address and a base sequence number. The software can configure the network interface device with a flow rule or policy including base sequence number and byte increment for the RTP flow. The receiver network interface device can determine memory addresses at which to start writing the payload of the received packet based on an offset computed based on buffer address+[current sequence number−base sequence number]*byte increment. A header buffer can refer to a base or first buffer, and headers do not need to be stored in an order, as a header buffer can be an available buffer address made available in a descriptor to the network interface device. However, headers can be stored in a same order as that of payloads. The receiver network interface device can copy a header of the RTP packet to a buffer and can copy a payload of the RTP packet to a second buffer.

FIG. 6B depicts an example of allocation of buffers to reorder lines of frames. In this example, two buffers are shown, but, in other examples, more than two buffers can be allocated to reorder lines of frames. In this example, buffers are allocated in memory to store 1080 lines of frame N and 1080 lines of frame N+1, however, other numbers of lines can be stored and reordered depending on a resolution of the frame, such as 2160 lines for 4K video or 720 lines for 720p. For a video frame that includes 1080 lines, approximately 4320 packets carry the lines of the video frame.

A reordering window can be used to account for received lines of one or more frames, as described herein. A reassembly context can be utilized per time stamp or frame to account for received lines of a video frame in received packets. The reassembly context can identify the buffer in memory that stores As described herein, a packet header can convey a frame identifier (ID) and the network interface device can identify a frame and lines (or portions thereof) received in a packet based on the packet header. A packet can include data starting from a middle of a line, as identified by a line offset from a start of a frame (e.g., FIG. 5A). Network interface device can copy lines in a payload of the packet to the buffer in a continuous manner based on the line offset so that lines are ordered from first line (e.g., line 0) to last line (e.g., line 1079). Software (e.g., application executed by a host system or server) monitors for a frame that has been completely written to a buffer. Reassembly contexts can be reused for other frames recycled when or after a frame is completely written to a buffer.

A reorder window size (in time units) can be smaller or equal to the equivalent latency of N−1 frames, where N is the amount of frames managed by the device queue. Inter-frame latency is defined by the frame rate (e.g., frames per second (fps)). In case the reorder window is violated, then there is risk for the process to be corrupted as the delayed old frame may be considered a new frame (if network interface device only checks that the timestamp is unique). If network interface device can identify that timestamp is older than the last context, then packet can be dropped or delivered to a different queue, so software can process the packet.

FIG. 6C depicts an example of a manner of allocating buffers to frames. In this example, Frames N to N+3 are allocated in memory starting at base address 0, based address 1, base address 2, and base address 3.

FIG. 6D depicts an example of allocation of lines from received packets to frames. Packet (P) N can carry a portion of line 1079 of frame K. Packets N+1 to N+3 can carry portions of line 0 of frame K+1. Packet N+3 can also carry a portion of line 1 of frame K+1. A line offset of packet N+1 can be zero to indicate data in packet N+1 starts a byte zero into the line 0. However, a line offset of packet N+2 and line offset of packet N+1 can be respective 100 and 130 to indicate a byte offset from a start of line 0 of frame K+1. The network interface device can map a payload of a packet to a specific video frame, specific line, and specific offset from start of line, and store the payload in a buffer based on the specific video frame, specific line, and specific offset from start of line.

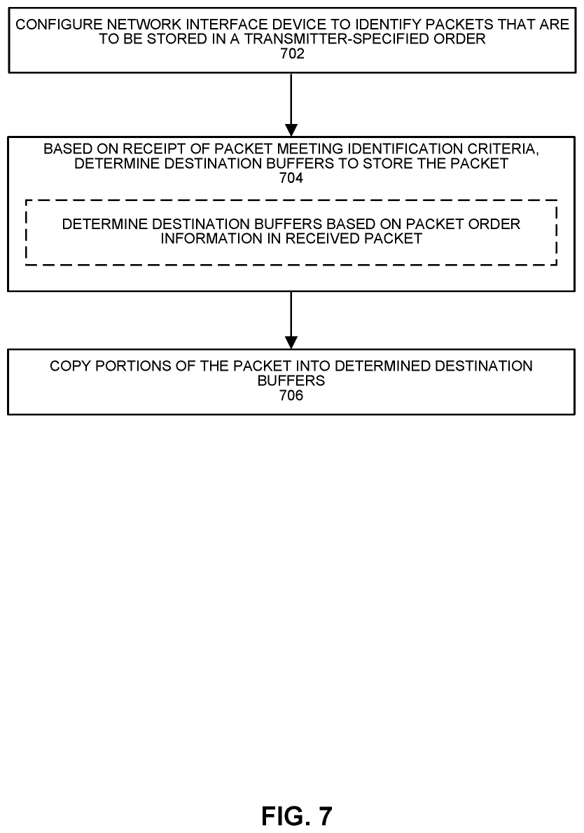

FIG. 7 depicts an example process. At 702, a driver can configure a network interface device to identify one or more packets having contents that are to be stored among multiple buffers. For example, the driver can configure the network interface device to store headers and payloads of particular flows of packets in an order specified by the transmitter in buffers in memory. For example, the packets can be part of a media stream or a reliable transport protocol with ordering to be performed at a receiver.

At 704, based on receipt of a packet that is associated with the configuration, the network interface device can determine one or more buffers to store portions of the received packet. For example, the buffers or memory addresses can be identified based on packet order information in a header of the received packet. For example, for received RTP packets, the buffers or memory addresses can be identified based on a base address for the RTP packets and one or more of line number, timestamp, length, line offset, or other information to derive a position in a buffer of the received packet. For example, for received RTP packets, the buffers or memory addresses can be identified based on a base address for the RTP packets and on: one or more of current sequence number, a starting sequence number, and byte offset.

At 706, the network interface device can copy portions of received packets that meet the identified configuration to determined multiple buffers. The buffers can be in host memory or memory accessible to a processor. Accordingly, at a receiver, an order of packet contents can comply with a transmitter-specified order of data.

FIG. 8 depicts an example network interface device. Various hardware and software resources in the network interface can be configured to determine buffers or destination addresses to which to copy portions of received packets, as described herein. In some examples, network interface 800 can be implemented as a network interface controller, network interface card, a host fabric interface (HFI), or host bus adapter (HBA), and such examples can be interchangeable. Network interface 800 can be coupled to one or more servers using a bus, PCIe, CXL, or DDR. Network interface 800 may be embodied as part of a system-on-a-chip (SoC) that includes one or more processors, or included on a multichip package that also contains one or more processors.

Some examples of network device 800 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 800 can include transceiver 802, processors 804, transmit queue 806, receive queue 808, memory 810, and bus interface 812, and DMA engine 852. Transceiver 802 can be capable of receiving and transmitting packets in conformance with the applicable protocols such as Ethernet as described in IEEE 802.3, although other protocols may be used. Transceiver 802 can receive and transmit packets from and to a network via a network medium (not depicted). Transceiver 802 can include PHY circuitry 814 and media access control (MAC) circuitry 816. PHY circuitry 814 can include encoding and decoding circuitry (not shown) to encode and decode data packets according to applicable physical layer specifications or standards. MAC circuitry 816 can be configured to perform MAC address filtering on received packets, process MAC headers of received packets by verifying data integrity, remove preambles and padding, and provide packet content for processing by higher layers. MAC circuitry 816 can be configured to assemble data to be transmitted into packets, that include destination and source addresses along with network control information and error detection hash values.

Processors 804 can be any a combination of: a processor, core, graphics processing unit (GPU), field programmable gate array (FPGA), application specific integrated circuit (ASIC), or other programmable hardware device that allow programming of network interface 800. For example, a “smart network interface” or SmartNIC can provide packet processing capabilities in the network interface using processors 804.

Processors 804 can include a programmable processing pipeline that is programmable by Programming Protocol-independent Packet Processors (P4), Software for Open Networking in the Cloud (SONiC), C, Python, Broadcom Network Programming Language (NPL), NVIDIA® CUDA®, NVIDIA® DOCA™, Infrastructure Programmer Development Kit (IPDK), or x86 compatible executable binaries or other executable binaries. A programmable processing pipeline can include one or more match-action units (MAUs) that can schedule packets for transmission using one or multiple granularity lists, as described herein. Processors, FPGAs, other specialized processors, controllers, devices, and/or circuits can be used utilized for packet processing or packet modification. Ternary content-addressable memory (TCAM) can be used for parallel match-action or look-up operations on packet header content. Processors 804 can be configured to classify packets and determine buffers or destination addresses to which to copy portions of received packets, as described herein.

Packet allocator 824 can provide distribution of received packets for processing by multiple CPUs or cores using receive side scaling (RSS). When packet allocator 824 uses RSS, packet allocator 824 can calculate a hash or make another determination based on contents of a received packet to determine which CPU or core is to process a packet.

Interrupt coalesce 822 can perform interrupt moderation whereby network interface interrupt coalesce 822 waits for multiple packets to arrive, or for a time-out to expire, before generating an interrupt to host system to process received packet(s). Receive Segment Coalescing (RSC) can be performed by network interface 800 whereby portions of incoming packets are combined into segments of a packet. Network interface 800 can provide this coalesced packet to an application.

Direct memory access (DMA) engine 852 can copy a packet header, packet payload, and/or descriptor directly from host memory to the network interface or vice versa, instead of copying the packet to an intermediate buffer at the host and then using another copy operation from the intermediate buffer to the destination buffer.

Memory 810 can be any type of volatile or non-volatile memory device and can store any queue or instructions used to program network interface 800. Transmit queue 806 can include data or references to data for transmission by network interface. Receive queue 808 can include data or references to data that was received by network interface from a network. Descriptor queues 820 can include descriptors that reference data or packets in transmit queue 806 or receive queue 808. Bus interface 812 can provide an interface with host device (not depicted). For example, bus interface 812 can be compatible with or based at least in part on PCI, PCI Express, PCI-x, Serial ATA, and/or USB (although other interconnection standards may be used), or proprietary variations thereof.

FIG. 9 depicts an example computing system. Components of system 900 (e.g., network interface 950, and so forth) can be configured to determine buffers or destination addresses to which to copy portions of received packets, as described herein. System 900 includes processor 910, which provides processing, operation management, and execution of instructions for system 900. Processor 910 can include any type of microprocessor, central processing unit (CPU), graphics processing unit (GPU), processing core, or other processing hardware to provide processing for system 900, or a combination of processors. Processor 910 controls the overall operation of system 900, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 900 includes interface 912 coupled to processor 910, which can represent a higher speed interface or a high throughput interface for system components that needs higher bandwidth connections, such as memory subsystem 920 or graphics interface components 940, or accelerators 942. Interface 912 represents an interface circuit, which can be a standalone component or integrated onto a processor die. Where present, graphics interface 940 interfaces to graphics components for providing a visual display to a user of system 900. In one example, graphics interface 940 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 940 generates a display based on data stored in memory 930 or based on operations executed by processor 910 or both. In one example, graphics interface 940 generates a display based on data stored in memory 930 or based on operations executed by processor 910 or both.

Accelerators 942 can be a fixed function or programmable offload engine that can be accessed or used by a processor 910. For example, an accelerator among accelerators 942 can provide compression (DC) capability, cryptography services such as public key encryption (PKE), cipher, hash/authentication capabilities, decryption, or other capabilities or services. In some embodiments, in addition or alternatively, an accelerator among accelerators 942 provides field select controller capabilities as described herein. In some cases, accelerators 942 can be integrated into a CPU socket (e.g., a connector to a motherboard or circuit board that includes a CPU and provides an electrical interface with the CPU). For example, accelerators 942 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 942 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 920 represents the main memory of system 900 and provides storage for code to be executed by processor 910, or data values to be used in executing a routine. Memory subsystem 920 can include one or more memory devices 930 such as read-only memory (ROM), flash memory, one or more varieties of random access memory (RAM) such as DRAM, or other memory devices, or a combination of such devices. Memory 930 stores and hosts, among other things, operating system (OS) 932 to provide a software platform for execution of instructions in system 900. Additionally, applications 934 can execute on the software platform of OS 932 from memory 930. Applications 934 represent programs that have their own operational logic to perform execution of one or more functions. Processes 936 represent agents or routines that provide auxiliary functions to OS 932 or one or more applications 934 or a combination. OS 932, applications 934, and processes 936 provide software logic to provide functions for system 900. In one example, memory subsystem 920 includes memory controller 922, which is a memory controller to generate and issue commands to memory 930. It will be understood that memory controller 922 could be a physical part of processor 910 or a physical part of interface 912. For example, memory controller 922 can be an integrated memory controller, integrated onto a circuit with processor 910.

In some examples, OS 932 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, NVIDIA®, Broadcom®, IBM®, Texas Instruments®, among others. In some examples, a driver can configure network interface 950 to determine buffers or destination addresses to which to copy portions of received packets and to copy portions of received packets to the determined buffers, as described herein.

While not specifically illustrated, it will be understood that system 900 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 900 includes interface 914, which can be coupled to interface 912. In one example, interface 914 represents an interface circuit, which can include standalone components and integrated circuitry. In one example, multiple user interface components or peripheral components, or both, couple to interface 914. Network interface 950 provides system 900 the ability to communicate with remote devices (e.g., servers or other computing devices) over one or more networks. Network interface 950 can include an Ethernet adapter, wireless interconnection components, cellular network interconnection components, USB (universal serial bus), or other wired or wireless standards-based or proprietary interfaces. Network interface 950 can transmit data to a device that is in the same data center or rack or a remote device, which can include sending data stored in memory. Network interface 950 (e.g., packet processing device) can execute a virtual switch to provide virtual machine-to-virtual machine communications for virtual machines (or other VEEs) in a same server or among different servers.

Some examples of network interface 950 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

In one example, system 900 includes one or more input/output (I/O) interface(s) 960. I/O interface 960 can include one or more interface components through which a user interacts with system 900 (e.g., audio, alphanumeric, tactile/touch, or other interfacing). Peripheral interface 970 can include any hardware interface not specifically mentioned above. Peripherals refer generally to devices that connect dependently to system 900. A dependent connection is one where system 900 provides the software platform or hardware platform or both on which operation executes, and with which a user interacts.

In one example, system 900 includes storage subsystem 980 to store data in a nonvolatile manner. In one example, in certain system implementations, at least certain components of storage 980 can overlap with components of memory subsystem 920. Storage subsystem 980 includes storage device(s) 984, which can be or include any conventional medium for storing large amounts of data in a nonvolatile manner, such as one or more magnetic, solid state, or optical based disks, or a combination. Storage 984 holds code or instructions and data 986 in a persistent state (e.g., the value is retained despite interruption of power to system 900). Storage 984 can be generically considered to be a “memory,” although memory 930 is typically the executing or operating memory to provide instructions to processor 910. Whereas storage 984 is nonvolatile, memory 930 can include volatile memory (e.g., the value or state of the data is indeterminate if power is interrupted to system 900). In one example, storage subsystem 980 includes controller 982 to interface with storage 984. In one example controller 982 is a physical part of interface 914 or processor 910 or can include circuits or logic in both processor 910 and interface 914.

A volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). Another example of volatile memory includes cache or static random access memory (SRAM).

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, or NVM devices that use chalcogenide phase change material (for example, chalcogenide glass).

A power source (not depicted) provides power to the components of system 900. More specifically, power source typically interfaces to one or multiple power supplies in system 900 to provide power to the components of system 900. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 900 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

FIG. 10 depicts an example system. In this system, IPU 1000 manages performance of one or more processes using one or more of processors 1006, processors 1010, accelerators 1020, memory pool 1030, or servers 1040-0 to 1040-N, where N is an integer of 1 or more. In some examples, processors 1006 of IPU 1000 can execute one or more processes, applications, VMs, containers, microservices, and so forth that request performance of workloads by one or more of: processors 1010, accelerators 1020, memory pool 1030, and/or servers 1040-0 to 1040-N. IPU 1000 can utilize network interface 1002 or one or more device interfaces to communicate with processors 1010, accelerators 1020, memory pool 1030, and/or servers 1040-0 to 1040-N. IPU 1000 can utilize programmable pipeline 1004 to process packets that are to be transmitted from network interface 1002 or packets received from network interface 1002. Programmable pipeline 1004 and/or processors 1006 can be configured to determine buffers or destination addresses to which to copy portions of received packets and to copy portions of received packets to the determined buffers, as described herein.

Embodiments herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), on-premises data centers, off-premises data centers, edge network elements, fog network elements, and/or hybrid data centers (e.g., data center that use virtualization, cloud and software-defined networking to deliver application workloads across physical data centers and distributed multi-cloud environments).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes one or more examples, and includes an apparatus comprising: a network interface device comprising: circuitry to perform header splitting with payload reordering for one or more packets received at the network interface device and circuitry to copy headers and/or payloads associated with the one or more packets to at least one memory device.

Example 2 includes one or more examples, wherein the perform header splitting with payload reordering for one or more packets received at the network interface device comprises perform payload reordering into buffers based on a transmitter-specified order.

Example 3 includes one or more examples, wherein the perform header splitting with payload reordering for one or more packets received at the network interface device comprises: split one or more received packets into headers and payloads; store a header of the headers into a first buffer; select a second buffer based on offset specified in a received packet of the one or more received packets; and store a payload of the payloads into the second buffer.

Example 4 includes one or more examples, wherein contents of the one or more received packets comprises an offset and wherein the perform header splitting with payload reordering for one or more packets received at the network interface device comprises determine at least one buffer to which to copy portions of the one or more received packets based on a base address of a destination memory address and the offset.

Example 5 includes one or more examples, wherein the offset is based on one or more of: sequence numbers, length, line number, length, or a base sequence number.

Example 6 includes one or more examples, comprising processor-executed software to perform header reordering into at least one buffer for the one or more packets received at the network interface device.

Example 7 includes one or more examples, wherein the packet processing device comprises one or more of: network interface controller (NIC), a remote direct memory access (RDMA)-enabled NIC, SmartNIC, router, switch, forwarding element, infrastructure processing unit (IPU), or data processing unit (DPU).

Example 8 includes one or more examples, comprising a server comprising a memory, wherein the server is communicatively coupled to the network interface device and wherein the memory comprises the at least one memory device.

Example 9 includes one or more examples, comprising a datacenter, wherein the datacenter includes the server and the network interface device and a second network interface device that is to transmit packets to the network interface device and specify an order of payload storage in the at least one memory device.

Example 10 includes one or more examples, and includes at least one non-transitory computer-readable medium comprising instructions stored thereon, that if executed by one or more processors, cause the one or more processors to: configure a network interface device to: perform header splitting with payload reordering for one or more packets received at the network interface device and copy headers and/or payloads associated with the one or more packets to at least one memory device.

Example 11 includes one or more examples, wherein the perform header splitting with payload reordering for one or more packets received at the network interface device comprises perform payload reordering into buffers based on a transmitter-specified order.

Example 12 includes one or more examples, wherein contents of the one or more received packets comprises an offset and wherein the perform header splitting with payload reordering for one or more packets received at the network interface device comprises determine at least one buffer to which to copy payloads of the one or more received packets based on a base address of a destination memory address and the offset.

Example 13 includes one or more examples, wherein the offset is based on one or more of: sequence numbers, length, line number, length, or a base sequence number.

Example 14 includes one or more examples, comprising instructions stored thereon, that if executed by one or more processors, cause the one or more processors to: perform header reordering into at least one buffer for the one or more packets received at the network interface device.

Example 15 includes one or more examples, wherein a driver is to configure the packet processing device.

Example 16 includes one or more examples, and includes a method comprising: performing header splitting with payload reordering for one or more packets received at a network interface device and copying headers and/or payloads associated with the one or more packets to at least one memory device.

Example 17 includes one or more examples, wherein the performing header splitting with payload reordering for one or more packets received at the network interface device comprises performing payload reordering into buffers based on a transmitter-specified order.

Example 18 includes one or more examples, wherein contents of the one or more received packets comprises an offset and wherein the performing header splitting with payload reordering for one or more packets received at the network interface device comprises determining at least one buffer to which to copy portions of the one or more received packets based on a base address of a destination memory address and the offset.

Example 19 includes one or more examples, wherein the offset is based on one or more of: sequence numbers, length, line number, length, or a base sequence number.

Example 20 includes one or more examples, and includes performing header reordering into at least one buffer for the one or more packets received at the network interface device.

What is claimed is:

1. An apparatus comprising:
a network interface device comprising:
circuitry to perform header splitting with payload reordering for one or more packets received at the network interface device and
circuitry to copy headers and/or payloads associated with the one or more packets to at least one memory device.

2. The apparatus of claim 1, wherein the perform header splitting with payload reordering for one or more packets received at the network interface device comprises perform payload reordering into buffers based on a transmitter-specified order.

3. The apparatus of claim 1, wherein the perform header splitting with payload reordering for one or more packets received at the network interface device comprises:
split one or more received packets into headers and payloads;
store a header of the headers into a first buffer;
select a second buffer based on offset specified in a received packet of the one or more received packets; and
store a payload of the payloads into the second buffer.

4. The apparatus of claim 1, wherein contents of the one or more received packets comprises an offset and wherein the perform header splitting with payload reordering for one or more packets received at the network interface device comprises determine at least one buffer to which to copy portions of the one or more received packets based on a base address of a destination memory address and the offset.

5. The apparatus of claim 4, wherein the offset is based on one or more of: sequence numbers, length, line number, length, or a base sequence number.

6. The apparatus of claim 1, comprising processor-executed software to perform header reordering into at least one buffer for the one or more packets received at the network interface device.

7. The apparatus of claim 1, wherein the packet processing device comprises one or more of: network interface controller (NIC), a remote direct memory access (RDMA)-enabled NIC, SmartNIC, router, switch, forwarding element, infrastructure processing unit (IPU), or data processing unit (DPU).

8. The apparatus of claim 1, comprising a server comprising a memory, wherein the server is communicatively coupled to the network interface device and wherein the memory comprises the at least one memory device.

9. The apparatus of claim 8, comprising a datacenter, wherein the datacenter includes the server and the network interface device and a second network interface device that is to transmit packets to the network interface device and specify an order of payload storage in the at least one memory device.

10. At least one non-transitory computer-readable medium comprising instructions stored thereon, that if executed by one or more processors, cause the one or more processors to:
configure a network interface device to:
perform header splitting with payload reordering for one or more packets received at the network interface device and
copy headers and/or payloads associated with the one or more packets to at least one memory device.

11. The at least one computer-readable medium of claim 10, wherein the perform header splitting with payload reordering for one or more packets received at the network interface device comprises perform payload reordering into buffers based on a transmitter-specified order.

12. The at least one computer-readable medium of claim 11, wherein contents of the one or more received packets comprises an offset and wherein the perform header splitting with payload reordering for one or more packets received at the network interface device comprises determine at least one buffer to which to copy payloads of the one or more received packets based on a base address of a destination memory address and the offset.

13. The at least one computer-readable medium of claim 12, wherein the offset is based on one or more of: sequence numbers, length, line number, length, or a base sequence number.

14. The at least one computer-readable medium of claim 10, comprising instructions stored thereon, that if executed by one or more processors, cause the one or more processors to:
perform header reordering into at least one buffer for the one or more packets received at the network interface device.

15. The at least one computer-readable medium of claim 10, wherein a driver is to configure the packet processing device.

16. A method comprising:
performing header splitting with payload reordering for one or more packets received at a network interface device and
copying headers and/or payloads associated with the one or more packets to at least one memory device.

17. The method of claim 16, wherein the performing header splitting with payload reordering for one or more packets received at the network interface device comprises performing payload reordering into buffers based on a transmitter-specified order.

18. The method of claim 16, wherein contents of the one or more received packets comprises an offset and wherein the performing header splitting with payload reordering for one or more packets received at the network interface device comprises determining at least one buffer to which to copy portions of the one or more received packets based on a base address of a destination memory address and the offset.

19. The method of claim 18, wherein the offset is based on one or more of: sequence numbers, length, line number, length, or a base sequence number.

20. The method of claim 16, comprising:
performing header reordering into at least one buffer for the one or more packets received at the network interface device.
